(19) United States
(12) Patent Application Publication
(10) Pub. No.: US 2025/0129578 A1
(43) Pub. Date: Apr. 24, 2025

(54) SYSTEM, METHOD, AND PROGRAM FOR CONTROLLING WORK MACHINE

(71) Applicant: Komatsu Ltd., Tokyo (JP)

(72) Inventors: Hikaru SUZUKI, Tokyo (JP); Tsutomu IWAMURA, Tokyo (JP); Sho NOZAKI, Tokyo (JP); Ryuji KANDA, Tokyo (JP); Daishi IWANAGA, Tokyo (JP); Tomokazu HIRAO, Tokyo (JP); Yuta UCHIDA, Tokyo (JP); Yuki SHIMANO, Tokyo (JP); Jun SASAKI, Tokyo (JP); Jin KITAJIMA, Tokyo (JP)

(21) Appl. No.: 18/685,062

(22) PCT Filed: Sep. 29, 2022
(86) PCT No.: PCT/JP22/36525

§ 371 Date: Feb. 20, 2024

(30) Foreign Application Priority Data
Sep. 30, 2021 (JP) 2021-161174

(51) Int. Cl. E02F 9/26; E02F 3/36; E02F 3/43

(52) U.S. Cl. CPC E02F 9/265; E02F 3/3681; E02F 3/437

(57) ABSTRACT

A measured value acquisition unit acquires measured values from a plurality of sensors. A position and posture calculation unit calculates a current posture of the work tool, based on the measured values. A target posture determination unit determines a virtual rotation axis, based on the calculated current posture of the work tool, when a predetermined control start condition is satisfied. A rotation amount calculation unit generates a control signal of the tilt rotator for rotating the work tool from the current posture to a target posture by a predetermined amount around the virtual rotation axis. A control signal output unit outputs the generated control signal.

### TECHNICAL FIELD

The present disclosure relates to a system, a method, and a program for controlling a work machine.

Priority is claimed on Japanese Patent Application No. 2021-161174, filed on Sep. 30, 2021, the content of which is incorporated herein by reference.

### BACKGROUND ART

Patent Literature 1 discloses a control system for a construction machine (work machine) including a tilt-rotatable tilt bucket. As described above, a work machine is known, which is equipped with a plurality of rotation mechanisms rotatable around different axes from each other and can rotate a work tool such as a bucket as desired.

### CITATION LIST

### Patent Literature

### Patent Literature 1

Japanese Unexamined Patent Application, First Publication No. 2020-125599

### SUMMARY OF INVENTION

### Technical Problem

Incidentally, a tilt rotator is known which rotatably supports an attachment of a work machine around three mutually orthogonal axes. By attaching the tilt rotator to the work machine, the attachment can be directed in any direction. On the other hand, in work machines such as hydraulic excavators, when loading soil or the like onto the bed of a dump truck, there is a desire to avoid spilling soil as much as possible during the process of moving the bucket onto the bed. However, as described above, in the hydraulic excavator equipped with the plurality of rotation mechanisms, when the bucket is attempted to be moved in a state where a width direction (a direction along the teeth) of the bucket is not horizontal, soil loaded into the bucket tends to spill out while being transported to the bed of the dump truck. Therefore, it is preferable to adjust the width direction of the bucket horizontally when moving the bucket.

On the other hand, in the hydraulic excavator equipped with the tilt rotator, it is assumed that the opening direction of the bucket is aligned with an excavation surface by using the rotation mechanism of the hydraulic excavator. Therefore, in consideration of efficiency of excavation work, there is a demand that an opening direction of the bucket is not desired to be changed before and after the loading operation of the dump truck.

An object of the present disclosure is to provide a system, a method, and a program that can simplify an operation of aligning a second reference direction (for example, the tooth direction of a bucket) with a predetermined plane (for example, a vehicle body reference plane), without changing a first reference direction (for example, an opening direction of the bucket) of a work tool, in a work machine including the work tool supported by the work equipment via a tilt rotator.

### Solution to Problem

According to an aspect of the present disclosure, there is provided a system for controlling a work machine including work equipment operably supported by a vehicle body, a tilt rotator attached to a distal end of the work equipment, and a work tool supported to be rotatable around three axes intersecting with each other in different planes with respect to the work equipment via the tilt rotator, the system including a processor. The processor acquires measured values from a plurality of sensors. The processor calculates a current posture of the work tool based on the measured values. The processor determines a virtual rotation axis, based on the calculated current posture of the work tool, when a predetermined control start condition is satisfied. The processor generates a control signal of a tilt rotator for rotating the work tool from the current posture to a target posture by a predetermined amount around the virtual rotation axis. The processor outputs the generated control signal.

### Advantageous Effects of Invention

According to the above aspect, in the work machine including the work tool supported by the work equipment via the tilt rotator, an operation of aligning a second reference direction with a predetermined plane without changing a first reference direction of the work tool can be simplified.

### BRIEF DESCRIPTION OF DRAWINGS

FIG. 1 is a schematic diagram showing a configuration of a work machine 100 according to a first embodiment.

FIG. 2 is a diagram showing a configuration of a tilt rotator 163 according to the first embodiment.

FIG. 3 is a diagram showing the configuration of a drive system of the work machine 100 according to the first embodiment.

FIG. 4 is a schematic block diagram showing the configuration of a control device 200 according to the first embodiment.

FIG. 5 is a flowchart showing an angle alignment function in the first embodiment.

FIG. 6 is a diagram showing details of an operation device in the first embodiment.

FIG. 7 is a view showing an action and effect of the angle alignment function in the first embodiment.

FIG. 8 is a view showing an action and effect of the angle alignment function in the first embodiment.

### DESCRIPTION OF EMBODIMENTS

### First Embodiment

### Configuration of Work Machine

Hereinafter, an embodiment will be described in detail with reference to the drawings.

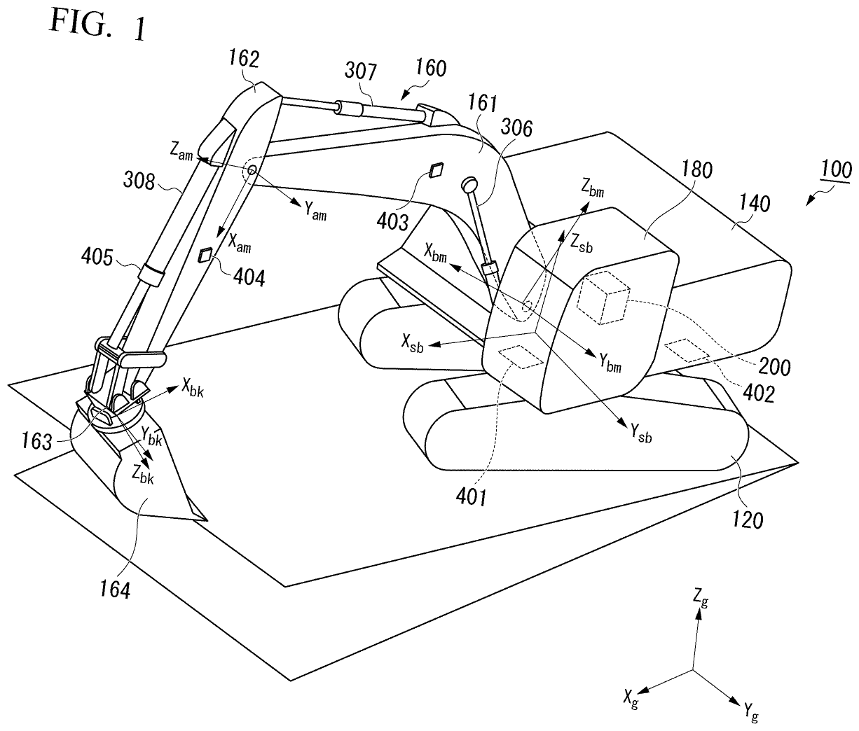

FIG. 1 is a schematic diagram showing a configuration of a work machine 100 according to a first embodiment. The work machine 100 according to the first embodiment is, for example, a hydraulic excavator. The work machine 100 includes an undercarriage 120, a swing body 140, work equipment 160, a cab 180, and a control device 200. The work machine 100 according to the first embodiment is controlled such that the teeth of the bucket 164 do not exceed the design surface.

The undercarriage 120 travellably supports the work machine 100. The undercarriage 120 is, for example, a pair of left and right endless tracks.

The swing body 140 is supported by the undercarriage 120 to be swingable around a swing center.

The work equipment 160 is operably supported by the swing body 140. The work equipment 160 is driven by hydraulic pressure. The work equipment 160 includes a boom 161, an arm 162, a tilt rotator 163, and a bucket 164 that is a work tool. The base end portion of the boom 161 is rotatably attached to the swing body 140. The base end portion of the arm 162 is rotatably attached to the distal end portion of the boom 161. The tilt rotator 163 is rotatably attached to the distal end portion of the arm 162. The bucket 164 is attached to the tilt rotator 163. The bucket 164 is rotatably supported around three axes intersecting with each other on different planes with respect to the work equipment 160 via the tilt rotator 163. Here, a portion of the swing body 140 to which the work equipment 160 is attached is called a front portion. In addition, with respect to the swing body 140, on the basis of the front portion, the opposite portion is referred to as a rear portion, a portion on the left side is referred to as a left portion, and a portion on the right side is referred to as a right portion.

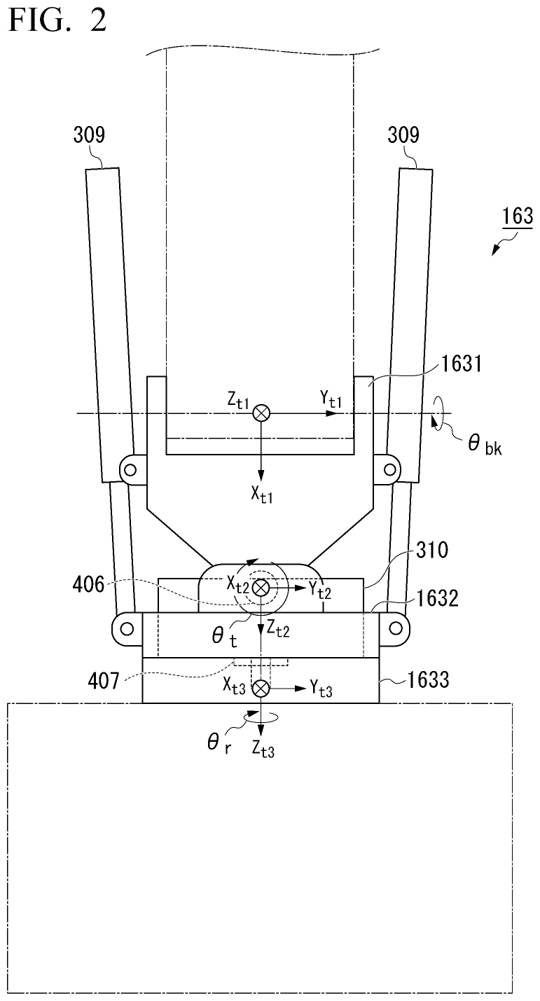

FIG. 2 is a diagram showing a configuration of the tilt rotator 163 according to the first embodiment. The tilt rotator 163 is attached to the distal end of the arm 162 to support the bucket 164. The tilt rotator 163 includes an attachment portion 1631, a tilt portion 1632, and a rotation portion 1633. The attachment portion 1631 is attached to the distal end of the arm 162 so as to be rotatable around an axis extending in the left-right direction in the drawing. The tilt portion 1632 is attached to the attachment portion 1631 to be rotatable around an axis extending in the front-rear direction in the drawing. The rotation portion 1633 is attached to the tilt portion 1632 so as to be rotatable around an axis extending in the up-down direction in the drawing. Ideally, the rotation axes of the attachment portion 1631, the tilt portion 1632, and the rotation portion 1633 are orthogonal to each other. The base end portion of the bucket 164 is fixed to the rotation portion 1633. Accordingly, the bucket 164 can rotate with respect to the arm 162 about three axes orthogonal to each other. However, in reality, there is a possibility that the rotation axes of the attachment portion 1631, the tilt portion 1632, and the rotation portion 1633 include design errors and are not orthogonal to each other.

The cab 180 is provided at the front portion of the swing body 140. An operation device 271 for an operator to operate the work machine 100, and a monitor device 272 which is a man-machine interface of the control device 200 are provided in the cab 180. The operation device 271 receives an input of the operation amount of a traveling motor 304 from an operator, the operation amount of a swing motor 305, the operation amount of a boom cylinder 306, the operation amount of an arm cylinder 307, the operation amount of a bucket cylinder 308, the operation amount of a tilt cylinder 309, and the operation amount of a rotary motor 310. The monitor device 272 receives an input for setting and releasing the bucket posture holding mode from an operator. The bucket posture holding mode is a mode in which the control device 200 controls the bucket cylinder 308, the tilt cylinder 309, and the rotary motor 310 to automatically hold the posture of the bucket 164 in the global coordinate system. The monitor device 272 is implemented by, for example, a computer including a touch panel.

The control device 200 controls the undercarriage 120, the swing body 140, and the work equipment 160, based on the operation of the operation device 271 by the operator. The control device 200 is provided, for example, inside the cab 180.

### Drive System of Work Machine 100

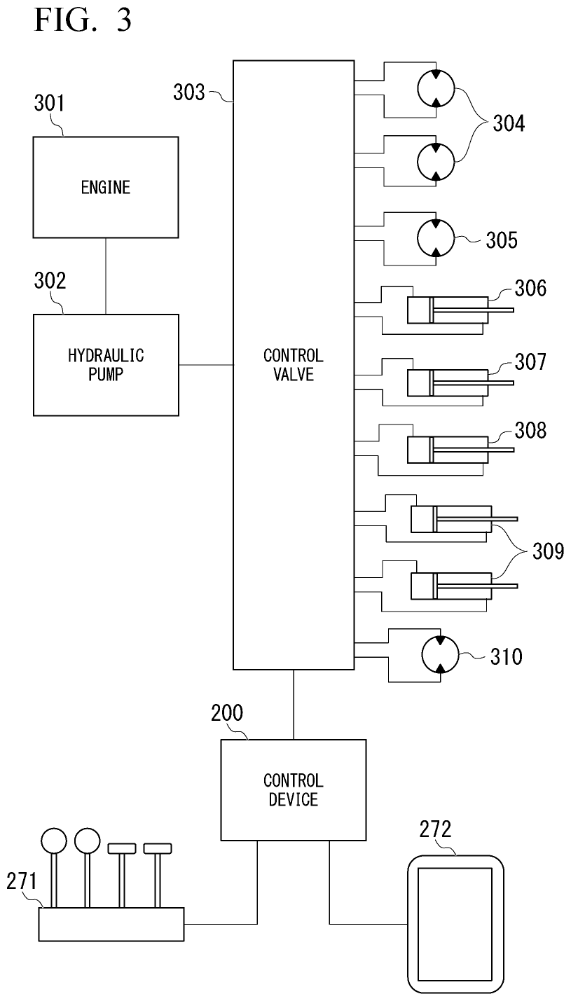

FIG. 3 is a diagram showing the configuration of a drive system of the work machine 100 according to the first embodiment.

The work machine 100 includes a plurality of actuators for driving the work machine 100. Specifically, the work machine 100 includes an engine 301, a hydraulic pump 302, a control valve 303, a pair of traveling motors 304, the swing motor 305, the boom cylinder 306, the arm cylinder 307, the bucket cylinder 308, the tilt cylinder 309, and the rotary motor 310.

The engine 301 is a prime mover that drives the hydraulic pump 302.

The hydraulic pump 302 is driven by the engine 301 and supplies hydraulic oil to the traveling motor 304, the swing motor 305, the boom cylinder 306, the arm cylinder 307, and the bucket cylinder 308 via the control valve 303.

The control valve 303 controls the flow rate of the hydraulic oil to be supplied from the hydraulic pump 302 to the traveling motor 304, the swing motor 305, the boom cylinder 306, the arm cylinder 307, and the bucket cylinder 308.

The traveling motor 304 is driven by the hydraulic oil supplied from the hydraulic pump 302 to drive the undercarriage 120.

The swing motor 305 is driven by the hydraulic oil supplied from the hydraulic pump 302 and causes the swing body 140 to swing with respect to the undercarriage 120.

The boom cylinder 306 is a hydraulic cylinder that drives the boom 161. The base end portion of the boom cylinder 306 is attached to the swing body 140. The distal end portion of the boom cylinder 306 is attached to the boom 161.

The arm cylinder 307 is a hydraulic cylinder for driving the arm 162. The base end portion of the arm cylinder 307 is attached to the boom 161. The distal end portion of the arm cylinder 307 is attached to the arm 162.

The bucket cylinder 308 is a hydraulic cylinder for driving the tilt rotator 163 and the bucket 164. The base end portion of the bucket cylinder 308 is attached to the arm 162. The distal end portion of the bucket cylinder 308 is attached to the tilt rotator 163 via a link member.

The tilt cylinder 309 is a hydraulic cylinder for driving the tilt portion 1632. The base end portion of the tilt cylinder 309 is attached to the attachment portion 1631. The distal end portion of the rod of the tilt cylinder 309 is attached to the tilt portion 1632.

The rotary motor 310 is a hydraulic motor for driving the rotation portion 1633. The bracket and stator of the rotary motor 310 are fixed to the tilt portion 1632. The rotation axis and rotor of the rotary motor 310 are provided to extend in the up-down direction in the drawing and are fixed to the rotation portion 1633.

### Measurement System of Work Machine 100

The work machine 100 includes a plurality of sensors for measuring the posture, azimuth direction, and position of the work machine 100. Specifically, the work machine 100 includes an inclination measurer 401, a position/azimuth direction measurer 402, a boom angle sensor 403, an arm angle sensor 404, a bucket angle sensor 405, a tilt angle sensor 406, and a rotation angle sensor 407.

The inclination measurer 401 measures the posture of the swing body 140. The inclination measurer 401 measures inclination (for example, roll angle, pitch angle, and yaw angle) of the swing body 140 with respect to a horizontal plane. Examples of the inclination measurer 401 include an inertial measurement unit (IMU). In this case, the inclination measurer 401 measures the acceleration and angular velocity of the swing body 140 and calculates the inclination of the swing body 140 with respect to the horizontal plane on the basis of the measurement result. The inclination measurer 401 is provided, for example, below the cab 180. The inclination measurer 401 outputs the posture data of the swing body 140, which is a measured value, to the control device 200.

The position/azimuth direction measurer 402 measures a position of a representative point of the swing body 140 and an azimuth direction in which the swing body 140 faces by a global navigation satellite system (GNSS). The position/azimuth direction measurer 402 includes, for example, two GNSS antennas (not shown) attached to the swing body 140, and measures an azimuth direction orthogonal to a straight line connecting positions of the two antennas as an azimuth direction in which the work machine 100 faces. The position/azimuth direction measurer 402 outputs position data and azimuth direction data of the swing body 140, which are measured values, to the control device 200.

The boom angle sensor 403 measures a boom angle, which is the angle of the boom 161 with respect to the swing body 140. The boom angle sensor 403 may be an IMU attached to the boom 161. In this case, the boom angle sensor 403 measures the boom angle, based on the inclination of the boom 161 with respect to the horizontal plane and the inclination of the swing body measured by the inclination measurer 401. The measured value of the boom angle sensor 403 indicates zero, for example, when the direction of a straight line passing through the base end and the distal end of the boom 161 coincides with the front-rear direction of the swing body 140. The boom angle sensor 403 according to another embodiment may be a stroke sensor attached to the boom cylinder 306. In addition, the boom angle sensor 403 according to another embodiment may be a rotation sensor provided at a joint shaft that rotatably connects the swing body 140 and the boom 161. The boom angle sensor 403 outputs boom angle data, which is the measured value, to the control device 200.

The arm angle sensor 404 measures an arm angle, which is the angle of the arm 162 with respect to the boom 161. The arm angle sensor 404 may be an IMU attached to the arm 162. In this case, the arm angle sensor 404 measures the arm angle, based on the inclination of the arm 162 with respect to the horizontal plane and the boom angle measured by the boom angle sensor 403. The measured value of the arm angle sensor 404 indicates zero, for example, when the direction of the straight line passing through the base end and the distal end of the arm 162 coincides with the direction of the straight line passing through the base end and the distal end of the boom 161. The arm angle sensor 404 according to another embodiment may calculate an angle by attaching a stroke sensor to the arm cylinder 307. In addition, the arm angle sensor 404 according to another embodiment may be a rotation sensor provided at a joint shaft that rotatably connects the boom 161 and the arm 162. The arm angle sensor 404 outputs arm angle data, which is the measured value, to the control device 200.

The bucket angle sensor 405 measures a bucket angle, which is the angle of the tilt rotator 163 with respect to the arm 162. The bucket angle sensor 405 may be a stroke sensor provided in the bucket cylinder 308. In this case, the bucket angle sensor 405 measures the bucket angle, based on the stroke amount of the bucket cylinder 308. The measured value of the bucket angle sensor 405 indicates zero, for example, when the direction of the straight line passing through the base end and the teeth of the bucket 164 coincides with the direction of the straight line passing through the base end and the distal end of the arm 162. Incidentally, the bucket angle sensor 405 according to another embodiment may be a rotation sensor provided on a joint shaft that rotatably connects the arm 162 and the attachment portion 1631 of the tilt rotator 163. In addition, the bucket angle sensor 405 according to another embodiment may be an IMU attached to the bucket 164. The bucket angle sensor 405 outputs bucket angle data, which is the measured value, to the control device 200.

The tilt angle sensor 406 measures a tilt angle, which is the angle of the tilt portion 1632 with respect to the attachment portion 1631 of the tilt rotator 163. The tilt angle sensor 406 may be a rotation sensor provided in a joint shaft that rotatably connects the attachment portion 1631 and the tilt portion 1632. The measured value of the tilt angle sensor 406 indicates zero, for example, when the rotation axis of the arm 162 and the rotation axis of the rotation portion 1633 are orthogonal to each other. The tilt angle sensor 406 according to another embodiment may calculate the angle by attaching the stroke sensor to the tilt cylinder 309. The tilt angle sensor 406 outputs tilt angle data, which is the measured value, to the control device 200.

The rotation angle sensor 407 measures a rotation angle, which is the angle of the rotation portion 1633 with respect to the tilt portion 1632 of the tilt rotator 163. The rotation angle sensor 407 may be a rotation sensor provided in the rotary motor 310. The measured value of the tilt angle sensor 406 indicates zero, for example, when the tooth direction of the bucket 164 and the operation plane of the work equipment 160 are orthogonal to each other. The rotation angle sensor 407 outputs rotation angle data, which is the measured value, to the control device 200.

### Configuration of Control Device 200

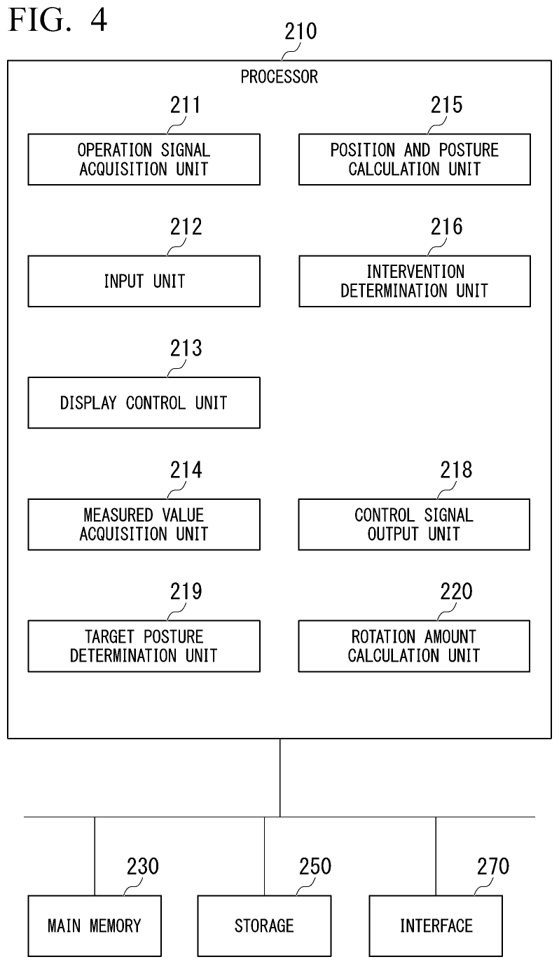

FIG. 4 is a schematic block diagram showing the configuration of the control device 200 according to the first embodiment.

The control device 200 is a computer that includes a processor 210, a main memory 230, a storage 250, and an interface 270. The control device 200 is an example of a control system. The control device 200 receives measured values from the inclination measurer 401, the position/azimuth direction measurer 402, the boom angle sensor 403, the arm angle sensor 404, the bucket angle sensor 405, the tilt angle sensor 406, and the rotation angle sensor 407.

The storage 250 is a non-transitory, tangible storage medium. As the storage 250, magnetic disks, optical disks, magneto-optical disks, semiconductor memories, and the like are exemplary examples. The storage 250 may be internal media directly connected to a bus of the control device 200, or may be external media connected to the control device 200 via the interface 270 or a communication line. The operation device 271 and the monitor device 272 are connected to the processor 210 via the interface 270.

The storage 250 stores control programs for controlling the work machine 100. The control programs may be for implementing part of the functions that the control device 200 is caused to exhibit. For example, the control program may function in combination with another program already stored in the storage 250 or in combination with another program implemented in another device. In addition, in other embodiments, the control device 200 may include a customized large scale integrated circuit (LSI) such as a programmable logic device (PLD) in addition to or instead of the above configuration. Examples of PLD include Programmable Array Logic (PAL), Generic Array Logic (GAL), Complex Programmable Logic Device (CPLD), and Field Programmable Gate Array (FPGA). In this case, part or all of the functions realized by the processor may be realized by the integrated circuit.

In the storage 250, geometric data representing dimensions and positions of the centers of gravity of the swing body 140, the boom 161, the arm 162, and the bucket 164 is recorded. The geometric data is data representing the position of an object in a predetermined coordinate system. In addition, design surface data, which is three-dimensional data representing the shape of the design surface at the construction site in the global coordinate system, is recorded in the storage 250. The global coordinate system is a coordinate system composed of an X_{g} axis extending in the latitude direction, a Y_{g} axis extending in the longitudinal direction, and a Z_{g} axis extending in the vertical direction. The design surface data is represented by, for example, Triangular Irregular Networks (TIN) data.

### Software Configuration

By executing the control program, the processor 210 includes an operation signal acquisition unit 211, an input unit 212, a display control unit 213, a measured value acquisition unit 214, a position and posture calculation unit 215, an intervention determination unit 216, a control signal output unit 218, a target posture determination unit 219, and a rotation amount calculation unit 220.

The operation signal acquisition unit 211 acquires an operation signal indicating an operation amount of each actuator from the operation device 271.

The input unit 212 receives an operation input by the operator from the monitor device 272.

The display control unit 213 outputs screen data to be displayed on the monitor device 272 to the monitor device 272.

The measured value acquisition unit 214 acquires measured values from the inclination measurer 401, the position/azimuth direction measurer 402, the boom angle sensor 403, the arm angle sensor 404, the bucket angle sensor 405, the tilt angle sensor 406, and the rotation angle sensor 407.

The position and posture calculation unit 215 calculates the position of the work machine 100 in the global coordinate system and the vehicle body coordinate system, based on various measured values acquired by the measured value acquisition unit 214 and the geometric data recorded in the storage 250. For example, the position and posture calculation unit 215 calculates positions of the teeth of the bucket 164 in the global coordinate system and the vehicle body coordinate system. The vehicle body coordinate system is a Cartesian coordinate system of which origin is a representative point of the swing body 140 (for example, a point passing through the swing center). The calculation by the position and posture calculation unit 215 will be described later.

The intervention determination unit 216 determines whether or not to limit the speed of the work equipment 160, based on the positional relationship between the positions of the teeth of the bucket 164 calculated by the position and posture calculation unit 215 and the design surface indicated by the design surface data. Hereinafter, limiting the speed of the work equipment 160 by the control device 200 is also referred to as intervention control. Specifically, the intervention determination unit 216 calculates the shortest distance between the design surface and the bucket 164, and determines to perform the intervention control on the work equipment 160 in a case where the shortest distance is equal to or less than a predetermined distance. Specifically, the intervention determination unit 216 rotates and translates the design surface data recorded in the storage 250, based on the measured values of the inclination measurer 401 and the position/azimuth direction measurer 402, and converts the position of the design surface represented in the global coordinate system into a position in the vehicle body coordinate system. The intervention determination unit 216 specifies, as the control point, the contour point having the shortest distance to the design surface among the plurality of contour points of the bucket 164. The intervention determination unit 216 specifies a surface (polygon) located vertically below the control point in the design surface data. The intervention determination unit 216 calculates a first design line, which is a line of intersection between a plane parallel to the X_{bk}-Z_{bk} plane of the bucket coordinate system passing through the control point and the specified plane. The intervention determination unit 216 determines whether or not the distance between the control point and the first design line is equal to or less than an intervention threshold value.

The control signal output unit 218 outputs the operation amount acquired by the operation signal acquisition unit 211 or the control signal of each actuator (the bucket cylinder 308, the tilt cylinder 309, and the rotary motor 310) according to the target values calculated by the rotation amount calculation unit 220, to the control valve 303.

The functions of the target posture determination unit 219 and the rotation amount calculation unit 220 will be described in detail when describing an angle alignment function described below.

### Calculation by Position and Posture Calculation Unit 215

Here, a method for calculating the position of the point on the outer shell of the work machine 100 by the position and posture calculation unit 215 will be described. The position and posture calculation unit 215 calculates the position of the point on the outer shell, based on various measured values acquired by the measured value acquisition unit 214 and the geometric data recorded in the storage 250. In the storage 250, geometric data representing dimensions of the swing body 140, the boom 161, the arm 162, the tilt rotator 163 (attachment portion 1631, tilt portion 1632, and rotation portion 1633), and the bucket 164 is recorded.

The geometric data of the swing body 140 indicates the center position (x_{bm}, y_{bm}, z_{bm}) of the joint shaft where the swing body 140 supports the boom 161, in the vehicle body coordinate system that is the local coordinate system. The vehicle body coordinate system is a coordinate system composed of an X_{sb} axis extending in the front-rear direction, a Y_{sb} axis extending in the left-right direction, and a Z_{sb} axis extending in the up-down direction with the swing center of the swing body 140 as a reference. The up-down direction of the swing body 140 does not necessarily coincide with the vertical direction.

The geometric data of the boom 161 indicates the position (xₐₘ, yₐₘ, zₐₘ) of the joint shaft where the boom 161 supports the arm 162, in the boom coordinate system that is the local coordinate system. The boom coordinate system is a coordinate system composed of an X_{bm} axis extending in a longitudinal direction, a Y_{bm} axis extending in a direction where the joint shaft extends, and a Z_{bm} axis orthogonal to the X_{bm} axis and the Y_{bm} axis, with a center position of the joint shaft connecting the swing body 140 and the boom 161 as a reference.

The geometric data of the arm 162 indicates the position (xₜ₁, yₜ₁, zₜ₁) of the joint shaft where the arm 162 supports the attachment portion 1631 of the tilt rotator 163, in the arm coordinate system that is the local coordinate system. The arm coordinate system is a coordinate system composed of an Xₐₘ axis extending in a longitudinal direction, a Yₐₘ axis extending in a direction where the joint shaft extends, and a Zₐₘ axis orthogonal to the Xₐₘ axis and the Yₐₘ axis, with a center position of the joint shaft connecting the boom 161 and the arm 162 as a reference.

The geometric data of the attachment portion 1631 of the tilt rotator 163 indicates the position (xₜ₂, yₜ₂, zₜ₂) of the joint shaft where the attachment portion 1631 supports the tilt portion 1632 and the inclination (φₜ) of the joint shaft, in the first tilt-rotate coordinate system that is the local coordinate system. The inclination φₜ of the joint shaft is an angle related to a design error of the tilt rotator 163, and is obtained by calibration of the tilt rotator 163 or the like. The first tilt-rotate coordinate system is a coordinate system composed of a Yₜ₁ axis extending in a direction where the joint shaft connecting the arm 162 and the attachment portion 1631 extends, a Zₜ₁ axis extending in a direction where the joint shaft connecting the attachment portion 1631 and the tilt portion 1632 extends, and a Xₜ₁ axis orthogonal to the Yₜ₁ axis and the Zₜ₁ axis, with the center position of the joint shaft connecting the arm 162 and the attachment portion 1631 as a reference.

The geometric data of the tilt portion 1632 of the tilt rotator 163 indicates the distal end position (xₜ₃, yₜ₃, zₜ₃) of the rotation axis of the rotary motor 310 and an inclination (φᵣ) of the rotation axis, in the second tilt-rotate coordinate system that is the local coordinate system. The inclination or of the rotation axis is an angle related to a design error of the tilt rotator 163, and is obtained by calibration of the tilt rotator 163 or the like. The second tilt-rotate coordinate system is a coordinate system composed of a Xₜ₂ axis extending in a direction where the joint shaft connecting the attachment portion 1631 and the tilt portion 1632 extends, a Zₜ₂ axis extending in a direction where the rotation axis of the rotary motor 310 extends, and a Yₜ₂ axis orthogonal to the Xₜ₂ axis and the Zₜ₂ axis, with the center position of the joint shaft connecting the attachment portion 1631 and the tilt portion 1632 as a reference.

The geometric data of the rotation portion 1633 of the tilt rotator 163 indicates the center position (xₜ₄, yₜ₄, zₜ₄) of the attachment surface of the bucket 164 in the third tilt-rotate coordinate system that is the local coordinate system. The third tilt-rotate coordinate system is a coordinate system composed of a Zₜ₃ axis extending in a direction where the rotation axis of the rotary motor 310 extends, and a Xₜ₃ axis and a Yₜ₃ axis orthogonal to the rotation axis, with the center position of the attachment surface of the bucket 164 as a reference. The bucket 164 is attached to the rotation portion 1633 such that the teeth are parallel to the Yₜ₃ axis.

The geometric data of the bucket 164 indicates the positions (x_{bk}, y_{bk}, z_{bk}) of the plurality of contour points of the bucket 164 in the third tilt-rotate coordinate system. Examples of the contour points include positions of both ends and the center of the teeth of the bucket 164, positions of both ends and the center of the bottom portion of the bucket 164, and positions of both ends and the center of the heel of the bucket 164.

The position and posture calculation unit 215 generates a boom-vehicle body conversion matrix T^{bm}_{sb} for conversion from the boom coordinate system to the vehicle body coordinate system by using the following Equation (1), based on the measured value of the boom angle θ_{bm} acquired by the measured value acquisition unit 214 and the geometric data of the swing body 140. The boom-vehicle body conversion matrix T^{bm}_{sb} is a matrix for rotating around the Y_{bm} axis by the boom angle θ_{bm} and translating by the deviation (x_{bm}, y_{bm}, z_{bm}) between the origin of the vehicle body coordinate system and the origin of the boom coordinate system.

$$\begin{matrix}Equation 1 & \\ {T}_{sb}^{bm} = [ \begin{matrix}cos {θ}_{bm} & 0 & sin {θ}_{bm} & {x}_{bm} \\ 0 & 1 & 0 & {y}_{bm} \\ - sin {θ}_{bm} & 0 & cos {θ}_{bm} & {z}_{bm} \\ 0 & 0 & 0 & 1\end{matrix} ] & ( 1 )\end{matrix}$$

The position and posture calculation unit 215 generates an arm-boom conversion matrix T^{am}_{bm} for conversion from the arm coordinate system to the boom coordinate system by using the following Equation (2), based on the measured value of the arm angle θₐₘ acquired by the measured value acquisition unit 214 and the geometric data of the boom 161. The arm-boom conversion matrix T^{am}_{bm} is a matrix for rotating around the Yₐₘ axis by the arm angle θₐₘ and translating by the deviation (xₐₘ, yₐₘ, zₐₘ) between the origin of the boom coordinate system and the origin of the arm coordinate system. In addition, the position and posture calculation unit 215 calculates a product of the boom-vehicle body conversion matrix T^{bm}_{sb} and the arm-boom conversion matrix T^{am}_{bm} to generate the arm-vehicle body conversion matrix T^{am}_{sb} for converting from the arm coordinate system to the vehicle body coordinate system.

$$\begin{matrix}Equation 2 & \\ {T}_{bm}^{am} = [ \begin{matrix}cos {θ}_{am} & 0 & sin {θ}_{am} & {x}_{am} \\ 0 & 1 & 0 & {y}_{am} \\ - sin {θ}_{am} & 0 & cos {θ}_{am} & {z}_{am} \\ 0 & 0 & 0 & 1\end{matrix} ] & ( 2 )\end{matrix}$$

The position and posture calculation unit 215 generates a first tilt-arm conversion matrix T^{t1}ₐₘ for conversion from the first tilt-rotate coordinate system to the arm coordinate system by using the following Equation (3), based on the measured value of the bucket angle θ_{bk} acquired by the measured value acquisition unit 214 and the geometric data of the arm 162. The first tilt-arm conversion matrix T^{t1}ₐₘ is a matrix that rotates around the Yₜ₁ axis by the bucket angle θ_{bk}, translates by the deviation (xₜ₁, yₜ₁, zₜ₁) between the origin of the arm coordinate system and the origin of the first tilt-rotate coordinate system, and further tilts by the inclination φₜ of the joint shaft of the tilt portion 1632. In addition, the position and posture calculation unit 215 calculates a product of the arm-vehicle body conversion matrix T^{am}_{sb} and the first tilt-arm conversion matrix Tt am to generate the first tilt-vehicle body conversion matrix T^{t1}_{sb} for converting from the first tilt-rotate coordinate system to the vehicle body coordinate system.

$$\begin{matrix}Equation 3 & \\ {T}_{bm}^{t 1} = [ \begin{matrix}cos ( {θ}_{bk} - {ϕ}_{t} ) & 0 & sin ( {θ}_{bk} - {ϕ}_{t} ) & {x}_{t 1} \\ 0 & 1 & 0 & {y}_{t 1} \\ - sin ( {θ}_{bk} - {ϕ}_{t} ) & 0 & cos ( {θ}_{bk} - {ϕ}_{t} ) & {z}_{t 1} \\ 0 & 0 & 0 & 1\end{matrix} ] & ( 3 )\end{matrix}$$

The position and posture calculation unit 215 generates a second tilt-first tilt conversion matrix T^{t2}ₜ₁ for conversion from the first tilt-rotate coordinate system to the second tilt-rotate coordinate system by using the following Equation (4), based on the measured value of the tilt angle θₜ acquired by the measured value acquisition unit 214 and the geometric data of the tilt rotator 163. The second tilt-first tilt conversion matrix T^{t2}ₜ₁ is a matrix that rotates around the Xₜ₂ axis by the tilt angle θₜ, translates by the deviation (xₜ₂, yₜ₂, zₜ₂) between the origin of the first tilt-rotate coordinate system and the origin of the second tilt-rotate coordinate system, and further tilts by the inclination or of the rotation axis of the rotation portion 1633. In addition, the position and posture calculation unit 215 calculates a product of the first tilt-vehicle body conversion matrix T^{t1}_{sb} and the second tilt-first tilt conversion matrix T^{t2}ₜ₁ to generate the second tilt-vehicle body conversion matrix T^{t2}_{sb} for converting from the second tilt-rotate coordinate system to the vehicle body coordinate system.

$$\begin{matrix}Equation 4 & \\ {T}_{t 1}^{t 2} = [ \begin{matrix}1 & 0 & 0 & {x}_{t 2} \\ 0 & cos {θ}_{t} & - sin {θ}_{t} & {y}_{t 2} \\ 0 & sin {θ}_{t} & cos {θ}_{t} & {z}_{t 2} \\ 0 & 0 & 0 & 1\end{matrix} ] [ \begin{matrix}cos {ϕ}_{r} & 0 & sin {ϕ}_{r} & 0 \\ 0 & 1 & 0 & 0 \\ - sin {ϕ}_{r} & 0 & cos {ϕ}_{r} & 0 \\ 0 & 0 & 0 & 1\end{matrix} ] & ( 4 )\end{matrix}$$

The position and posture calculation unit 215 generates a third tilt-second tilt conversion matrix T^{t3}ₜ₂ for conversion from the second tilt-rotate coordinate system to the third tilt-rotate coordinate system by using the following Equation (5), based on the measured value of the rotation angle θᵣ acquired by the measured value acquisition unit 214 and the geometric data of the tilt rotator 163. The third tilt-second tilt conversion matrix T^{t3}ₜ₂ is a matrix that rotates around the Zₜ₃ axis by the rotation angle θᵣ, and translates by the deviation (xₜ₃, yₜ₃, zₜ₃) between the origin of the second tilt-rotate coordinate system and the origin of the third tilt-rotate coordinate system. In addition, the position and posture calculation unit 215 calculates a product of the second tilt-vehicle body conversion matrix T^{t2}_{sb} and the third tilt-second tilt conversion matrix T^{t3}ₜ₂ to generate the third tilt-vehicle body conversion matrix T^{t3}_{sb} for converting from the third tilt-rotate coordinate system to the vehicle body coordinate system.

$$\begin{matrix}Equation 5 & \\ {T}_{t 2}^{t 3} = [ \begin{matrix}cos {θ}_{r} & - sin {θ}_{r} & 0 & {x}_{t 3} \\ sin {θ}_{r} & cos {θ}_{r} & 0 & {y}_{t 3} \\ 0 & 0 & 1 & {z}_{t 3} \\ 0 & 0 & 0 & 1\end{matrix} ] & ( 5 )\end{matrix}$$

The position and posture calculation unit 215 can calculate the positions of the plurality of contour points of the bucket 164 in the vehicle body coordinate system, by calculating the sum of the center positions (xₜ₄, yₜ₄, zₜ₄) of the attachment surface of the bucket 164 and the positions (x_{bk}, y_{bk}, z_{bk}) of the plurality of contour points in the third tilt-rotate coordinate system indicated by the geometric data of the bucket 164 and the product of the center positions (xₜ₄, yₜ₄, zₜ₄) and the third tilt-vehicle body conversion matrix T^{bk}_{sb}.

Incidentally, the angle of the teeth of the bucket 164 with respect to the ground plane of the work machine 100, that is, the angle formed by the X_{sb}-Y_{sb} plane of the vehicle body coordinate system and the Yₜ₃ axis of the third tilt-rotate coordinate system is determined by the boom angle θ_{bm}, the arm angle θₐₘ, the bucket angle θ_{bk}, the tilt angle θₜ, and the rotation angle θᵣ. Accordingly, as shown in FIG. 1, the position and posture calculation unit 215 specifies the bucket coordinate system starting from the base end portion of the bucket 164, that is, the center position of the attachment surface of the bucket 164 in the tilt rotator 163. The bucket coordinate system is a Cartesian coordinate system including an X_{bk} axis extending in a direction where the teeth of the bucket 164 face, a Y_{bk} axis orthogonal to the X_{bk} axis and extending along the teeth of the bucket 164, and a Z_{bk} axis orthogonal to the X_{bk} axis and the Y_{bk} axis. Hereinafter, the X_{bk} axis will also be referred to as a bucket tilt axis, the Y_{bk} axis will also be referred to as a bucket pitch axis, and the Z_{bk} axis will also be referred to as a bucket rotation axis. The bucket tilt axis X_{bk}, the bucket pitch axis Y_{bk}, and the bucket rotation axis Z_{bk} are virtual axes and are different from the joint shaft of the tilt rotator 163. Incidentally, when the inclination of the rotation axis of the rotary motor 310 is zero, the bucket coordinate system and the third tilt-rotate coordinate system coincide with each other.

The position and posture calculation unit 215 generates a bucket-third tilt conversion matrix T^{bk}ₜ₃ for converting the third tilt-rotate coordinate system into the bucket coordinate system according to the following Equation (6) based on the geometric data of the tilt rotator 163. The bucket-third tilt conversion matrix T^{bk}ₜ₃ is a matrix that rotates around the Yₜ₃ axis by the inclination or of the rotation axis.

$$\begin{matrix}Equation 6 & \\ {T}_{t 3}^{bk} = [ \begin{matrix}cos ( - {ϕ}_{r} ) & 0 & sin ( - {ϕ}_{r} ) & 0 \\ 0 & 1 & 0 & 0 \\ - sin ( - {ϕ}_{r} ) & 0 & cos ( - {ϕ}_{r} ) & 0 \\ 0 & 0 & 0 & 1\end{matrix} ] & ( 6 )\end{matrix}$$

### Angle Alignment Function

Hereinafter, an angle alignment function according to the present embodiment will be described in detail with reference to the drawings. Here, “angle alignment” means an operation of rotating the bucket 164 around the bucket tilt axis (X_{bk} axis) to cause the tooth direction (bucket pitch axis (Y_{bk} axis)) of the bucket 164 to be aligned with a vehicle body reference plane by a predetermined angle. The vehicle body reference plane is an X_{sb} axis-Y_{sb} axis plane (refer to FIG. 1) in the vehicle body coordinate system. In the present embodiment, the predetermined angle is an angle at which the teeth and the vehicle body reference plane are parallel to each other. Due to this operation, the teeth can be made parallel to the vehicle body reference plane without changing an opening direction of the bucket 164 (bucket tilt axis direction). The predetermined angle is not limited to an angle at which the teeth and the vehicle body reference plane are parallel to each other, and may be any angle determined by the operator.

First, the operation signal acquisition unit 211, the control signal output unit 218, the target posture determination unit 219, and the rotation amount calculation unit 220 in FIG. 4 will be described in detail.

In addition to the above-described functions, the operation signal acquisition unit 211 acquires an operation signal to an operation reception portion (hereinafter, also referred to as an angle alignment operation reception portion) dedicated for using the angle alignment function in the operation device 271.

When receiving an operation signal for performing angle alignment from the operation reception portion, the target posture determination unit 219 determines a target posture which is a posture obtained by rotating the bucket 164 around the virtual rotation axis from the current posture by a predetermined amount. The virtual rotation axis is a virtual rotation axis facing the opening direction of the bucket 164. In the present embodiment, the bucket tilt axis (X_{bk} axis, refer to FIG. 1) in the above-described bucket coordinate system is determined as the virtual rotation axis. The target posture is a posture in which a reference axis orthogonal to the virtual rotation axis has a predetermined angle with respect to a predetermined plane. The reference axis is an axis extending along the teeth of the bucket 164, and in the present embodiment, is a bucket pitch axis (Y_{bk} axis, refer to FIG. 1) in the above-described bucket coordinate system. The predetermined plane is a vehicle body reference plane.

The rotation amount calculation unit 220 calculates a rotation amount for each of the plurality of rotation mechanisms required to align the current posture of the bucket 164 with the target posture. Here, the plurality of rotation mechanisms in the present embodiment are the bucket cylinder 308, the tilt cylinder 309, and the rotary motor 310. As shown in FIGS. 1 and 2, the bucket cylinder 308 rotates the bucket 164 around the Yₜ₁ axis. The tilt cylinder 309 rotates the bucket 164 around the Xₜ₂ axis. In addition, the rotary motor 310 rotates the bucket 164 around the Zₜ₃ axis.

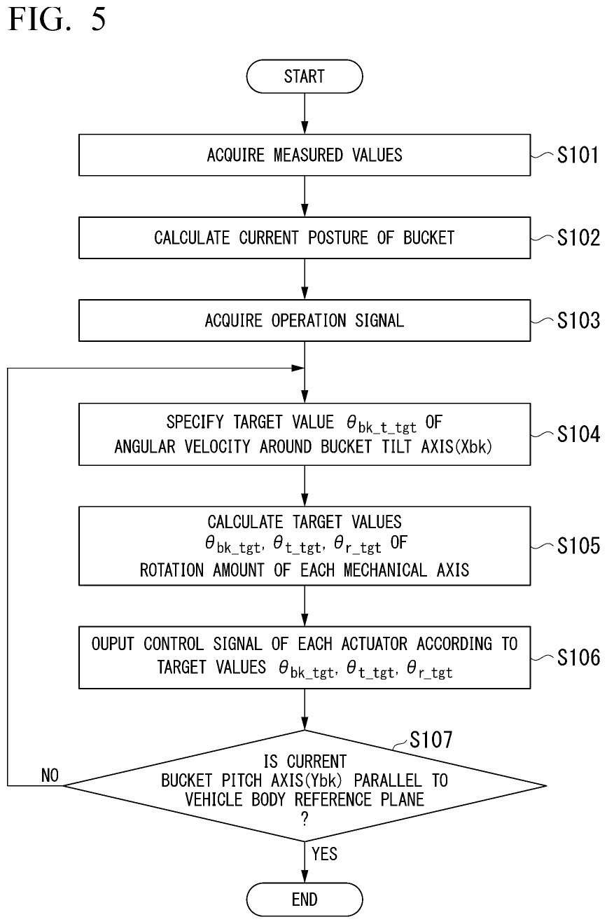

Next, a flow of processing of the angle alignment function by the control device 200 of the present embodiment will be described with reference to FIGS. 5 to 8.

FIG. 5 is a flowchart showing the angle alignment function in the first embodiment. When the operator of the work machine 100 starts to operate the work machine 100, the control device 200 executes the following controls at predetermined control cycles (for example, 1000 milliseconds).

First, the measured value acquisition unit 214 acquires measured values from the inclination measurer 401, the position/azimuth direction measurer 402, the boom angle sensor 403, the arm angle sensor 404, the bucket angle sensor 405, the tilt angle sensor 406, and the rotation angle sensor 407 (step S101).

The position and posture calculation unit 215 calculates the posture of the bucket in the vehicle body coordinate system based on the measured value acquired in step S101 (step S102). The posture of the bucket in the vehicle body coordinate system is represented by a posture matrix R_{cur} indicating a direction of each axis (X_{bk}, Y_{bk}, Z_{bk}) of the bucket coordinate system in the vehicle body coordinate system. All translation components of the posture matrix R_{cur} representing the posture of the bucket 164 are set to zero.

The operation signal acquisition unit 211 acquires an operation signal from the angle alignment operation reception portion by the operator (step S103).

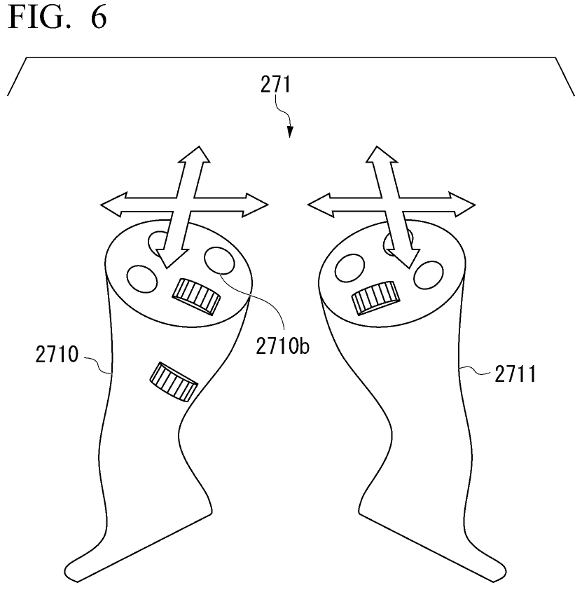

In the present embodiment, the operation device 271 is provided with, for example, two levers 2710 and 2711 as shown in FIG. 6. In the work machine 100 according to the present embodiment, as in a normal work machine, an operator can tilt the two levers 2710 and 2711 in the front-rear direction and the left-right direction, so that the operator can operate the swing operation of the swing body 140 or the boom angle θ_{bm}, the arm angle θₐₘ, and the bucket angle θ_{bk}, individually. In addition, the operator can individually control the tilt angle θₜ and the rotation angle θᵣ via the tilt rotator 163 by operating operation reception portions (button, slide switch, dial, and proportional roller type switch) provided on upper surface portions of the levers 2710 and 2711.

Furthermore, the operation device 271 according to the present embodiment includes an angle alignment operation reception portion 2710b in the lever 2710. The angle alignment operation reception portion 2710b is, for example, a press-type mechanical switch. The operator can execute angle alignment control at a desired timing by pressing the switch. In a case where a signal is acquired from the angle alignment operation reception portion 2710b, the processor determines that the predetermined control start condition is satisfied, and proceeds to the process of step S104.

Returning to FIG. 9, next, the target posture determination unit 219 determines the bucket tilt axis X_{bk} as a virtual rotation axis, and specifies a target value θ_{bk_t_tgt} of an angular velocity around the bucket tilt axis X_{bk} (step S104). The target value θ_{bk_t_tgt} may be a fixed value set in advance. Incidentally, specifying the target value θ_{bk_t_tgt} of the angular velocity around the bucket tilt axis X_{bk} is equivalent to determining the target posture that the bucket 164 should have after a unit time has elapsed from the present time point.

Next, the rotation amount calculation unit 220 calculates the target value of the rotation amount of each of the plurality of rotation mechanisms required to align the current posture of the bucket 164 with the target posture, based on the target value θ_{bk_t_tgt} specified by the target posture determination unit 219 (step S105).

Specifically, the rotation amount calculation unit 220 creates a rotation matrix R^{bk_t}_{bk} representing rotation around the bucket tilt axis X_{bk} in the bucket coordinate system by substituting the target value θ_{bk_t_tgt} of the angular velocity into the following Equation (7).

$$\begin{matrix}Equation 7 & \\ {R}_{b k}^{bk \_ t} = [ \begin{matrix}1 & 0 & 0 & 0 \\ 0 & cos {θ}_{bk \_ t \_ tgt} & - sin {θ}_{bk \_ t \_ tgt} & 0 \\ 0 & sin {θ}_{bk \_ t \_ tgt} & cos {θ}_{bk \_ t \_ tgt} & 0 \\ 0 & 0 & 0 & 1\end{matrix} ] & ( 7 )\end{matrix}$$

The rotation amount calculation unit 220 calculates the target posture R_{tgt} of the bucket 164 after a unit time by multiplying the matrix R_{cur} representing the current posture of the bucket 164 by the rotation matrix R^{bk_p}_{bk} in Equation (7). The rotation amount calculation unit 220 calculates the target values (θ_{bk_tgt}, θ_{t_tgt}, θ_{r_tgt}) of a bucket angle θ_{bk}, a tilt angle θₜ, and a rotation angle θᵣ by using the following Equations (8), (9), and (10), based on the current posture R_{cur} of the bucket 164 and the target posture R_{tgt} of the bucket 164 after the unit time.

$$\begin{matrix}Equation 8 & \\ {R}_{cur}^{T} {R}_{tgt} = [ \begin{matrix}{r}_{11} & {r}_{12} & {r}_{13} & 0 \\ {r}_{21} & {r}_{22} & {r}_{23} & 0 \\ {r}_{31} & {r}_{32} & {r}_{33} & 0 \\ 0 & 0 & 0 & 1\end{matrix} ] & ( 8 )\end{matrix}$$

$$\begin{matrix}Equation 9 & \\ θ = {cos}^{- 1} ( \frac{{r}_{11} + {r}_{22} + {r}_{33} - 1}{2} ) & ( 9 )\end{matrix}$$

$$\begin{matrix}Equation 10 & \\ [ \begin{matrix}{θ}_{t\_tgt} \\ {θ}_{bk\_tgt} \\ {θ}_{r\_tgt}\end{matrix} ] = \{ \begin{matrix}{[ 000 ]}^{T} & ( \vert θ \vert < ε ) \\ {KR}_{cur} \frac{θ}{2 sin θ} [ \begin{matrix}{r}_{32} - {r}_{23} \\ {r}_{13} - {r}_{31} \\ {r}_{21} - {r}_{12}\end{matrix} ] & ( \vert θ \vert \geq ε )\end{matrix} & ( 10 )\end{matrix}$$

As described above, by the matrix conversion, the target value (θ_{bk_t_tgt}) of the angular velocity around one virtual rotation axis (bucket tilt axis) is converted into the target value (θ_{bk_tgt}, θ_{t_tgt}, θ_{r_tgt}) of the angular velocity around the three machine axes.

Next, the control signal output unit 218 generates the control signal of each actuator (the bucket cylinder 308, the tilt cylinder 309, and the rotary motor 310) according to the target values (θ_{bk_tgt}, θ_{t_tgt}, θ_{r_tgt}) of the bucket angle θ_{bk}, the tilt angle θₜ, and the rotation angle θᵣ, and outputs the control signal of each actuator to the control valve 303 (step S106).

The posture of the bucket 164 actually changes by the control signal output unit 218 outputting the control signal of each actuator to the control valve 303. At this time, the target posture determination unit 219 acquires the changed current posture R_{cur} and determines whether or not the bucket pitch axis is parallel to the vehicle body reference plane (step S107).

When the bucket pitch axis (γ_{bk} axis) is not parallel to the vehicle body reference plane (step S107; NO), the process returns to step S104, and the target value (θ_{bk_t_tgt}) of the angular velocity around the bucket tilt axis (X_{bk} axis) is specified again. Accordingly, the process of step S105 by the rotation amount calculation unit 220 and the process of step S106 by the control signal output unit 218 are executed again.

On the other hand, when the bucket pitch axis (Y_{bk} axis) is parallel to the vehicle body reference plane (step S107; YES), the target posture determination unit 219, the rotation amount calculation unit 220, and the control signal output unit 218 end the process. Accordingly, the automatic angle alignment control by the control device 200 is completed.

### Actions and Effects

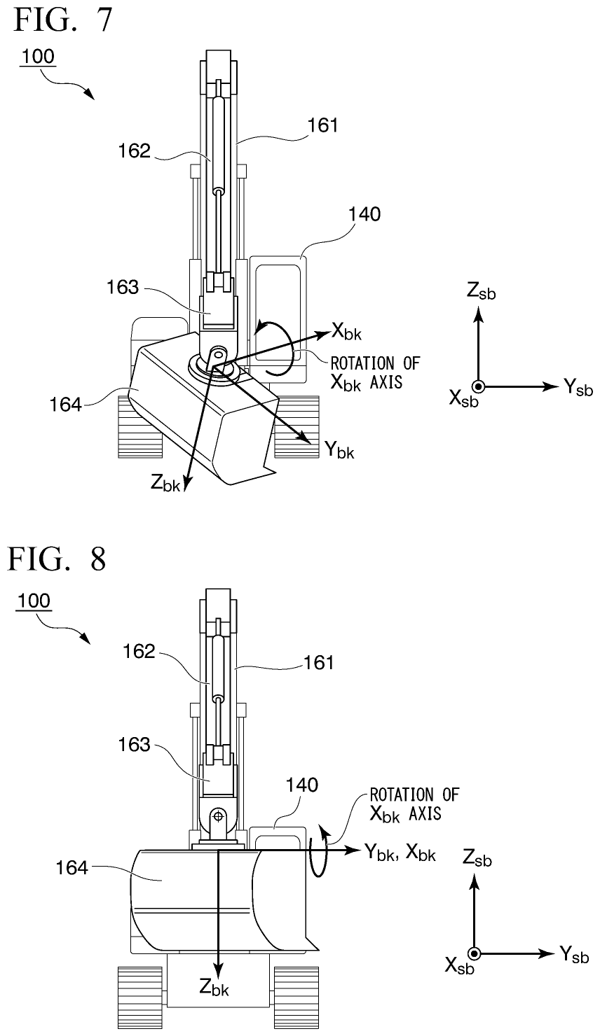

Next, an action and effect of the angle alignment function will be described with reference to FIGS. 7 and 8.

FIGS. 7 and 8 show a state in which the work machine 100 is viewed from the same angle.

Here, FIG. 7 shows a state immediately after excavation (scooping) is performed in a state where the tooth direction (bucket pitch axis (Y_{bk} axis)) of the bucket 164 is inclined with respect to the vehicle body reference plane (X_{sb}-Y_{sb} plane). The operator of the work machine 100 performs loading on the dump truck from this state.

The operator operates the boom 161 and the arm 162 to lift the bucket 164 upward in order to load the scooped soil onto a dump truck. However, when the tooth direction of the bucket 164 remains inclined, a part of the scooped soil spills down from the bucket 164. Therefore, the operator presses the operation reception portion 2710b (see FIG. 6) while operating the boom 161 and the arm 162 via the levers 2710 and 2711. Then, the bucket 164 automatically rotates around the bucket tilt axis (X_{bk} axis) and the bucket pitch axis (Y_{bk} axis) is controlled to be parallel to the vehicle body reference plane.

FIG. 8 shows a state immediately after the automatic angle alignment control is completed. As shown in FIG. 8, the tooth direction of the bucket 164 (bucket pitch axis (Y_{bk} axis)) is parallel to the vehicle body reference plane. On the other hand, the opening direction of the bucket 164 (bucket tilt axis (X_{bk} axis)) has not changed. Therefore, when the bucket 164 is fed back to the excavation surface again after the soil is dumped to the dump truck, a state where the opening surface of the bucket 164 is aligned with the excavation surface is maintained.

As described above, according to the control device 200 of the first embodiment, it is possible to simplify the operation for making the tooth direction of the bucket 164 parallel to the vehicle body reference plane, in the work machine 100 including the work equipment 160 to which the plurality of rotation mechanisms (the bucket cylinder 308, the tilt cylinder 309, and the rotary motor 310) and the bucket 164 are connected.

### Modification Example of First Embodiment

In the first embodiment described above, it has been described that the angle alignment control can be started at a desired timing by the operator pressing the operation reception portion 2710b. That is, in the first embodiment, the control start condition of the angle alignment function is the operation (pressing of the button) by the operator. However, another embodiment is not limited to this aspect. For example, a control device 200 according to the modification example of the first embodiment may have the following functions.

The target posture determination unit 219 according to a modification example of the first embodiment starts a process of determining the target posture, when the bucket 164 is separated from the ground by a predetermined distance as a control start condition of the angle alignment function.

For determining whether or not the bucket 164 is away from the ground by a predetermined distance, for example, the above-described function of the intervention determination unit 216 can be used. That is, the target posture determination unit 219 obtains the shortest distance between the position of the teeth of the bucket 164 and the design surface moment by moment via the intervention determination unit 216. Then, the target posture determination unit 219 determines that a predetermined control start condition is satisfied at a time point when the shortest distance calculated from moment to moment becomes equal to or larger than a predetermined determination threshold value while the bucket 164 that has scooped rises, and starts the process of step S104.

In this manner, an operation to be performed by the operator can be eliminated in a case where the angle alignment control is executed, and thus the loading work on the loading platform can be further simplified.

### Another Embodiment

The embodiments have been described above in detail with reference to the drawings; however, the specific configurations are not limited to the above-described configurations, and various design changes or the like can be made. That is, in another embodiment, the order of the above-described processing may be appropriately changed. In addition, some of the processing may be executed in parallel.

The control device 200 according to the above-described embodiment may be configured by a single computer, or the configuration of the control device 200 may be arranged to be divided into a plurality of computers, and the plurality of computers may function as the control device 200 by cooperating with each other. In this case, a part of the computers configuring the control device 200 may be mounted inside the work machine, and another computer may be provided outside the work machine. For example, in another embodiment, the operation device 271 and the monitor device 272 are provided remotely from the work machine 100, and the configuration other than the measured value acquisition unit 214 and the control signal output unit 218 in the control device 200 may be provided in the remote server.

Further, the work machine 100 according to the above-described embodiment is a hydraulic excavator, but is not limited to this. For example, the work machine 100 according to another embodiment may be a work machine that is fixed on the ground and does not self-travel. Further, the work machine 100 according to another embodiment may be a work machine that does not have a swing body.

The work machine 100 according to the above-described embodiment includes the bucket 164 as the attachment of the work equipment 160, but is not limited thereto. For example, the work machine 100 according to another embodiment may include a breaker, a fork, a grapple, and the like as an attachment. Even in this case, similarly to the bucket coordinate system, the control device 200 controls the tilt rotator 163 by the local coordinate system composed of the X_{bk} axis extending in the direction where the teeth of the attachment face, the Y_{bk} axis extending in the direction along the teeth, and the Z_{bk} axis that is orthogonal to the X_{bk} axis and the Y_{bk} axis.

In addition, in another embodiment, the axes of the tilt rotator 163 may not be orthogonal to each other as long as the axes intersect each other on different planes. Specifically, regarding an axis AX1 related to a joint shaft connecting the arm 162 and the attachment portion 1631, an axis AX2 related to a joint shaft connecting the attachment portion 1631 and the tilt portion 1632, and a rotation axis AX3 of the rotary motor 310, when the tilt angle and the rotation angle of the tilt rotator 163 are zero, a surface parallel to the axis AX1 and the axis AX2, a surface parallel to the axis AX2 and the axis AX3, and a surface parallel to the axis AX3 and the axis AX1 may be different from each other.

Further, the control device 200 according to another embodiment may not have a design surface setting function. Also in this case, the control device 200 can automatically control the tilt rotator 163 by performing the bucket posture holding control. For example, the operator can perform simple ground leveling work without setting the design surface.

### INDUSTRIAL APPLICABILITY

According to the above aspect, in the work machine including the work tool supported by the work equipment via the tilt rotator, an operation of aligning a second reference direction with a predetermined plane without changing a first reference direction of the work tool can be simplified.

### REFERENCE SIGNS LIST

100: Work machine
120: Undercarriage
140: Swing body
160: Work equipment
161: Boom
162: Arm
163: Tilt rotator
1631: Attachment portion
1632: Tilt portion
1633: Rotation portion
164: Bucket
180: Cab
200: Control device
210: Processor
211: Operation signal acquisition unit
212: Input unit
213: Display control unit
214: Measured value acquisition unit
215: Position and posture calculation unit
216: Intervention determination unit
218: Control signal output unit
219: Target posture determination unit
220: Rotation amount calculation unit
230: Main memory
250: Storage
270: Interface
271: Operation device
272: Monitor device
301: Engine
302: Hydraulic pump
303: Control valve
304: Traveling motor
305: Swing motor
306: Boom cylinder
307: Arm cylinder
308: Bucket cylinder
309: Tilt cylinder
310: Rotary motor
401: Inclination measurer
402: Position/azimuth direction measurer
403: Boom angle sensor
404: Arm angle sensor
405: Bucket angle sensor
406: Tilt angle sensor
407: Rotation angle sensor

1. A system for controlling a work machine including work equipment operably supported by a vehicle body, a tilt rotator attached to a distal end of the work equipment, and a work tool supported to be rotatable around three axes intersecting with each other in different planes with respect to the work equipment via the tilt rotator,
the system comprising a processor, wherein the processor is configured to:
acquire measured values from a plurality of sensors;
calculate a current posture of the work tool, based on the measured values;
determine a virtual rotation axis, based on the calculated current posture of the work tool, when a predetermined control start condition is satisfied;
generate a control signal of the tilt rotator for rotating the work tool from the current posture to a target posture by a predetermined amount around the virtual rotation axis; and
output the generated control signal.

2. The system according to claim 1, wherein the work tool has teeth, and the virtual rotation axis is an axis extending in a direction where the teeth of the work tool face.

3. The system according to claim 2, wherein the processor is configured to:
determine a reference axis orthogonal to the virtual rotation axis and extending along teeth of the work tool; and
set a posture in which the reference axis and a vehicle body reference plane are parallel to each other as the target posture.

4. The system according to claim 1, wherein the processor is configured to:
acquire a predetermined operation signal by an operator; and
generate the control signal of the tilt rotator for rotating the work tool from the current posture to the target posture by a predetermined amount around the virtual rotation axis, when the predetermined operation signal is received as the control start condition.

5. The system according to claim 1, wherein the processor is configured to determine the target posture, when the work tool is separated from a ground by a predetermined distance as the control start condition.

6. The system according to claim 1, wherein the virtual rotation axis is different from a joint shaft of the tilt rotator.

7. A method for controlling a work machine including work equipment operably supported by a vehicle body, a tilt rotator attached to a distal end of the work equipment, and a work tool supported to be rotatable around three axes intersecting with each other in different planes with respect to the work equipment via the tilt rotator, the method comprising:
a step of acquiring measured values from a plurality of sensors;
a step of calculating a current posture of the work tool, based on the measured values;
a step of determining a virtual rotation axis, based on the calculated current posture of the work tool, when a predetermined control start condition is satisfied;
a step of generating a control signal of the tilt rotator for rotating the work tool from the current posture to a target posture by a predetermined amount around the virtual rotation axis; and
a step of outputting the generated control signal.

8. A program causing a computer of a control system for a work machine including work equipment operably supported by a vehicle body, a tilt rotator attached to a distal end of the work equipment, and a work tool supported to be rotatable around three axes intersecting with each other in different planes with respect to the work equipment via the tilt rotator to execute:
a step of acquiring measured values from a plurality of sensors;
a step of calculating a current posture of the work tool, based on the measured values;
a step of determining a virtual rotation axis, based on the calculated current posture of the work tool, when a predetermined control start condition is satisfied;
a step of generating a control signal of a tilt rotator for rotating the work tool from the current posture to a target posture by a predetermined amount around the virtual rotation axis; and
a step of outputting the generated control signal.
